(19) United States
(12) Patent Application Publication
(10) Pub. No.: US 2015/0044005 A1
(43) Pub. Date: Feb. 12, 2015

(54) CONTAINER OFFLOAD SYSTEM

(71) Applicant: Paul Christopher Pitts, Dauphin Island, AL (US)

(72) Inventor: Paul Christopher Pitts, Dauphin Island, AL (US)

(73) Assignee: COMMODITY SHIPPING SOLUTIONS, LLC, Dauphin Island, AL (US)

(21) Appl. No.: 14/084,217

(22) Filed: Nov. 19, 2013

Related U.S. Application Data
(60) Provisional application No. 61/862,965, filed on Aug. 7, 2013.

(51) Int. Cl. B65G 67/24

(52) U.S. Cl. CPC B65G 67/24; B65G 2814/0217
USPC 414/416.03; 414/811

(57) ABSTRACT

Disclosed is a container offload system for shipping containers, silos, and other storage containers. The offload system is comprised of a longitudinal body with spacers attached to the bottom section, in contact with a commodity. Commodity passes through gaps between the spacers into an offload channel. The commodity is offloaded from the container or silo through the offload channel. The offload system is built into containers or may be retrofitted. Furthermore, versions of the offload system may be retrofitted to fit in the hull of a marine vessel. In one version, the offload system is removable.

### CROSS REFERENCES

This application claims the benefit of U.S. Provisional Application No. 61/862,965, filed on Aug. 7, 2013, which application is incorporated herein by reference.

### FIELD OF THE INVENTION

A preferred embodiment of a version of the invention refers to a container offload system for offloading commodities from a container.

### BACKGROUND

Storing and transporting goods is essential to modern life. However, current methods leave much to be desired. Various types of containers and storage methods are used at different points in the process of loading, transporting, unloading, and storing commodities. This process takes significant time, puts the commodities at risk of contamination at each transfer point, decreases overall yield, and decreases profitability and productivity due to lost time and goods.

Many goods are shipped via intermodal containers (also known as ISO containers). Generally, there are several basic types of ISO containers. These include flat racks, open-top, insulated, reefer, and tank containers. Loading these containers is generally done by dumping material into the top, loading material into the front doors, or filling the container through an inlet pipe. Tank containers are built to the same standard dimensions as other ISO containers, but are made up of one or more vessels mounted inside of a rectangular steel framework (also known as an exoskeleton). Generally, these containers have been used to transport liquid or bulk materials. Presently, tank containers are rarely utilized for shipping or storing dry commodities.

Offload systems, particularly relating to those in shipping containers, storage containers, and silos, are responsible for offloading material or commodities from the shipping container, storage tank, or silo to another container or end user. The methods currently used for offloading shipping containers and silos are time consuming, expensive, and dangerous.

For example, manual offloading of sacked or bagged commodities is one method for offloading bulk commodities. This process takes a great deal of time, requires significant labor, and is susceptible to product contamination by dropping, tearing, or otherwise compromising the sacked commodities. Another method is tipping a loaded container. Tipping open-top and dry freight containers is the primary method used to offload bulk commodities from shipping containers. However, leveraging a fully loaded container high above the ground presents dangerous conditions. If a mechanical error takes place, especially when the container is lifted high off the ground, the results could be devastating. Additionally, in inclement weather it is difficult or impossible to keep the commodities from being contaminated by rain, wind, and other debris falling from the container doors, truck mud flaps, or top of container.

Once the commodities are offloaded from the shipping container, the bulk commodity may remain in a pit, or may be loaded into some other storage tank, such as a silo or bin. If remaining in a pit until needed, the commodity is exposed to wind, rain, and other elements, thus putting the product at risk of contamination. If the bulk commodity is loaded into a storage bin or tank, a great deal of time and effort must again be expended to load the material into the final storage container. Additionally, the process of loading bulk material into silos and other storage tanks requires large, heavy, and expensive equipment. Furthermore, the process of loading and subsequently unloading a silo or storage tank is dangerous.

Therefore, a needs exists in the art for an offloading system for shipping containers, storage containers, silos and other storage tanks that is safer, faster, and less expensive than current methods. Furthermore, there is a need for a container offloading system that simplifies product offload, increases shipping efficiency, and protects commodities from exposure to the elements. Additionally, there is a need for a system and method for loading, shipping, storing, and unloading dry bulk commodities in the same container. There is a further need for an intermodal (ISO) container capable of transport and onsite storage.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A preferred embodiment of a version of the present invention is directed to a container offload system that satisfies the need to simplify product offload, increase shipping efficiency, and protect commodities. A further purpose of one embodiment of the present invention is to simplify the offload process based on a more efficient apparatus and process.

Nevertheless, embodiments of the invention are not limited to shipping containers, silos, and other storage tanks A version of the invention will generally find utility in any application that requires an efficient offload system for dry goods.

Generally, a preferred embodiment of a version of the invention comprises an offload system. Preferably, the offload system is made up of an upper section and a lower section. The lower section has a plurality of spacers connected thereto. The spacers are in contact with the commodity and allow controlled amounts of the commodity to pass through a gap between the spacers into a channel. The commodity is then offloaded from the container via the channel.

Some of the dry bulk goods consist of, but are not limited to, bauxite, bulk minerals (such as sand, gravel, copper, limestone, and salt), cement, chemicals (such as fertilizer, plastic granules, plastic pellets, citrus pellets, resin powder, and synthetic fiber), coal, dry edibles (such as alfalfa pellets, citrus pellets, livestock feed, flour, peanuts, raw or refined sugar, seeds, and starches), grain (such as wheat, corn, rice, barley, oats, rye, sorghum, and soybeans), iron (such as ferrous and non-ferrous ores, ferroalloys, and scrap metal) and wood chips.

Versions of the invention have many advantages over current systems. The following is a short set of advantages and is not meant to define all of the advantages of the versions of the present invention. One advantage of a preferred embodiment of a version of the invention is decreased contamination of commodity. Another advantage is that the commodity does not need to be transported from a shipping container to a storage container. Still another is decreased labor cost and time. Furthermore, the system has versatility in offloading various commodities. Additionally, the offload system can be retrofitted into existing containers. Furthermore, versions of the offload system may be retrofitted to fit in the hull of a marine vessel. Finally, the offload system of the present invention is safer than many current offload systems and methods.

### DESCRIPTION OF THE DRAWINGS

These and other features, aspects, and advantages of the present invention will become better understood with regard to the following description, appended claims, and accompanying drawing where:

FIG. 1A depicts a perspective view of an apparatus embodying features of the present invention for an offload system.

FIG. 1B is a bottom view of an apparatus embodying features of the present invention for an offload system.

FIG. 2A is a front interior view of an apparatus embodying features of the present invention for an offload system.

FIG. 2B is an exterior perspective view of an apparatus embodying features of the present invention for an offload system.

FIG. 3 is a front view of a container equipped with an apparatus embodying features of the present invention for an offload system.

FIG. 4 is a perspective view of an apparatus embodying features of the present invention for an offload system.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components, or can contain at least one component chosen from A, B, or C.

Where reference is made herein to a method comprising two ore more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

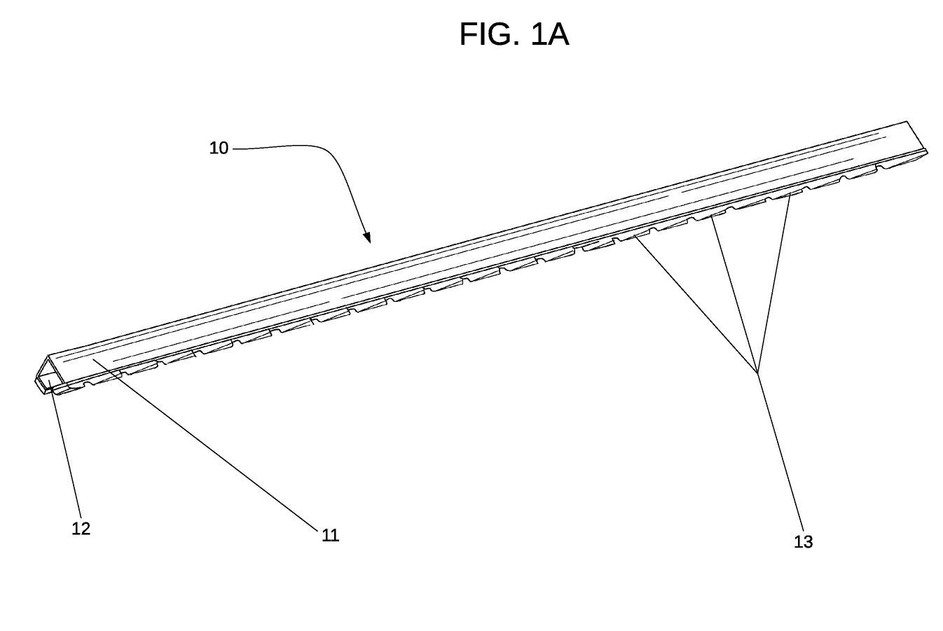

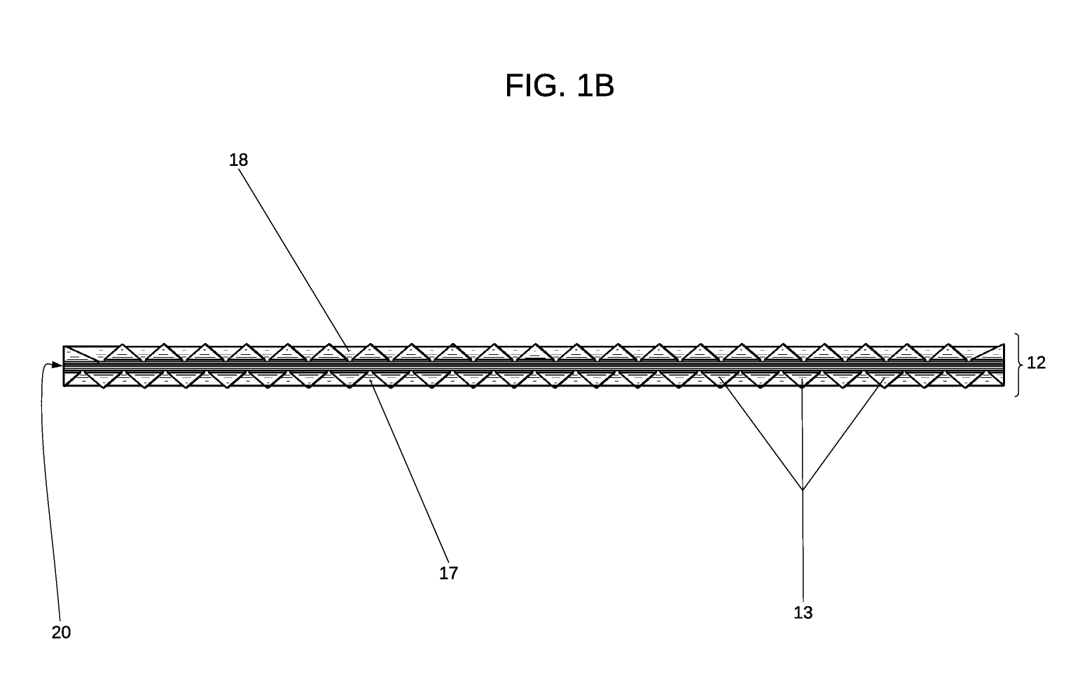

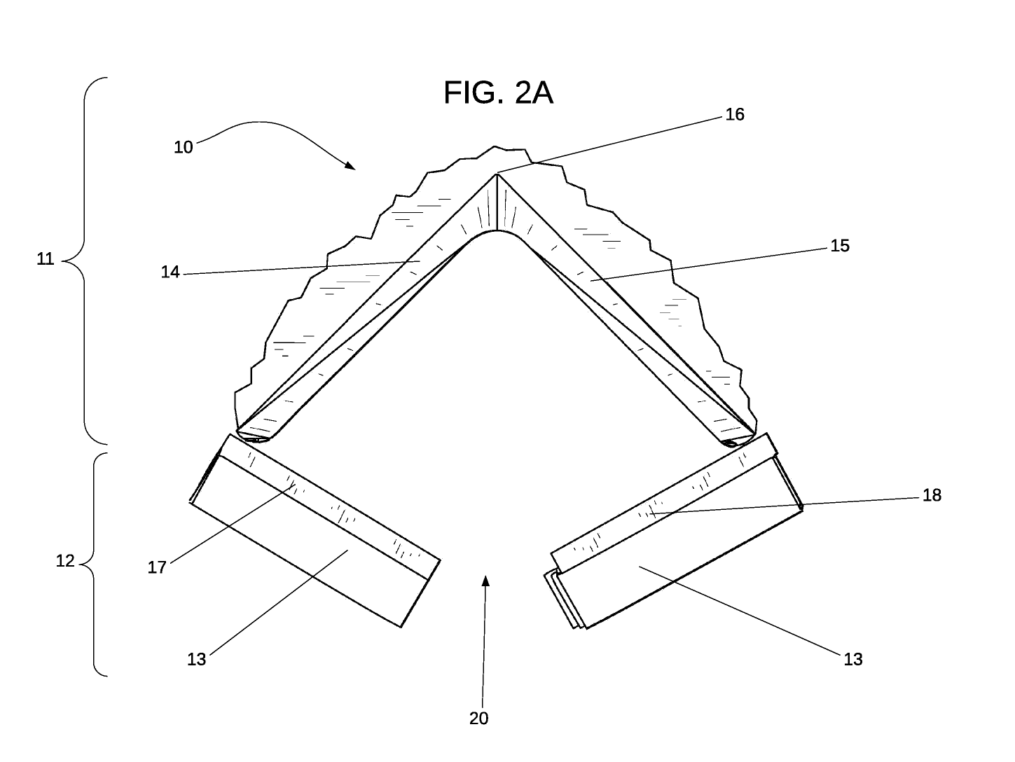

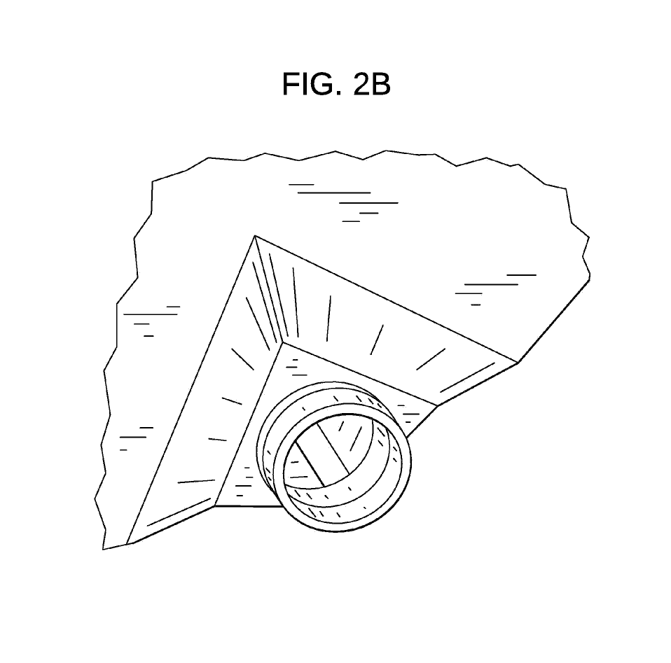

As noted in FIG. 1A, a preferred embodiment of a version of the invention is directed to a container offload system 10 comprising an upper section 11 and a lower section 12. The upper section 11 is attached to the lower section 12. As illustrated in FIG. 1B, a plurality of spacers 13 are connected to the lower section 12. As shown in FIGS. 1B and 2A, the lower section 12 has a space 20 for material to pass.

As further illustrated in FIG. 2A, an embodiment of a version of the invention is based on a container offload system 10 further comprising the upper section 11 is made up of a left 14 and right 15 piece. Each left 14 and right 15 piece of the upper section has a high and low side. The high side of each left and right piece of the upper section are joined together at a central point 16 so as to create no space between the pieces.

As illustrated in FIG. 2A, the lower section 12 is made up of a left 17 and a right 18 piece. Each left 17 and right 18 piece of the lower section 12 has a high and low side. The high side of the left piece of the lower section 17 is attached to the low side of the left piece of the upper section 14. The high side of the right piece of the lower section 18 is attached to the lower side of the right piece of the upper section 15. The low side of the right piece of the lower section 18 and the low side of the left piece lower section 17 create a space 20 there between.

As illustrated in FIG. 2A, an embodiment of a version of the invention comprises a container offload system comprising the lower sections 17 18 having spacers 13 connected to the bottom side of the lower sections 17 18 in contact with goods stored in the tank. The goods stored in the tank may be many different materials. In a preferred embodiment, the goods will be dry bulk goods. Some of the dry bulk goods consist of, but are not limited to, bauxite, bulk minerals (such as sand, gravel, copper, limestone, and salt), cement, chemicals (such as fertilizer, plastic granules, plastic pellets, citrus pellets, resin powder, and synthetic fiber), coal, dry edibles (such as alfalfa pellets, citrus pellets, livestock feed, flour, peanuts, raw or refined sugar, seeds, and starches), grain (such as wheat, corn, rice, barley, oats, rye, sorghum, and soybeans), iron (such as ferrous and non-ferrous ores, ferroalloys, and scrap metal) and wood chips.

A show in FIG. 1B a preferred embodiment of a version of the invention comprises spacers 13 attached to the lower section 12 having a triangular configuration. In a preferred embodiment, the spacers are made up of a durable hardened material. In one embodiment the spacers are comprised of hardened rubber. In another embodiment the spacers are comprised of metal.

As illustrated in FIG. 2A, in one embodiment of a version of the invention the spacers 13 are attached to the left 17 and right 18 pieces of the lower section. The spacers 13 of the left side 17 of the lower section are staggered with the spacers of the right side 18 of the lower section, as shown in FIG. 1B. As further shown in FIG. 1B, the staggering is such that a gap between two spacers 13 on the left piece 17 of the lower section 12 sits opposite from a spacer 13 on the right piece 18 of the lower section 12.

As illustrated in FIG. 1A, a preferred embodiment of a version of the invention comprises a container offload system 10 comprising a longitudinal body in the shape of a diamond with an open bottom for commodities to pass. It is further understood that versions of the invention comprise the longitudinal body being in the shape of a triangle. As noted in FIG. 2A, in a preferred embodiment the diamond shaped longitudinal body has an open bottom 20 forming a channel therein. The commodities pass through the open bottom 20 into the channel. The longitudinal body has an upper 11 and lower 12 section. The upper section 11 forms the upper portion of the longitudinal body diamond shape. An apex 16 of the upper section of the longitudinal body is joined together. The lower section of the longitudinal body is not joined together and has a separation 20 for commodities to pass.

An embodiment of a version of the invention further comprises the lower section 12 of the longitudinal body having spacers 13 attached thereto. The spacers 13 are attached to both sides of the lower section 12 of the longitudinal body. The spacers 13 are attached to exterior sides of the longitudinal body lower section 12 so as to be in contact with the commodity. In one embodiment, the spacers are triangles.

As illustrated in FIG. 1B, an embodiment of a version of the invention comprises the spacers 13 are triangles having a flat bottom and a pointed top. The flat bottom is located near the open space 20 at the bottom of the longitudinal section lower body 12. The top point is located farthest away from the open space 20 at the bottom of the longitudinal section lower body 12.

An embodiment of a version of the invention further comprises the spacers 13 are staggered on each side of the longitudinal body lower section 12 such that the middle of the bottom section of a spacer 13 on one side of the longitudinal section lower body 12 is opposite the gap between two spacers 13 on the opposite side of the longitudinal section lower body 12.

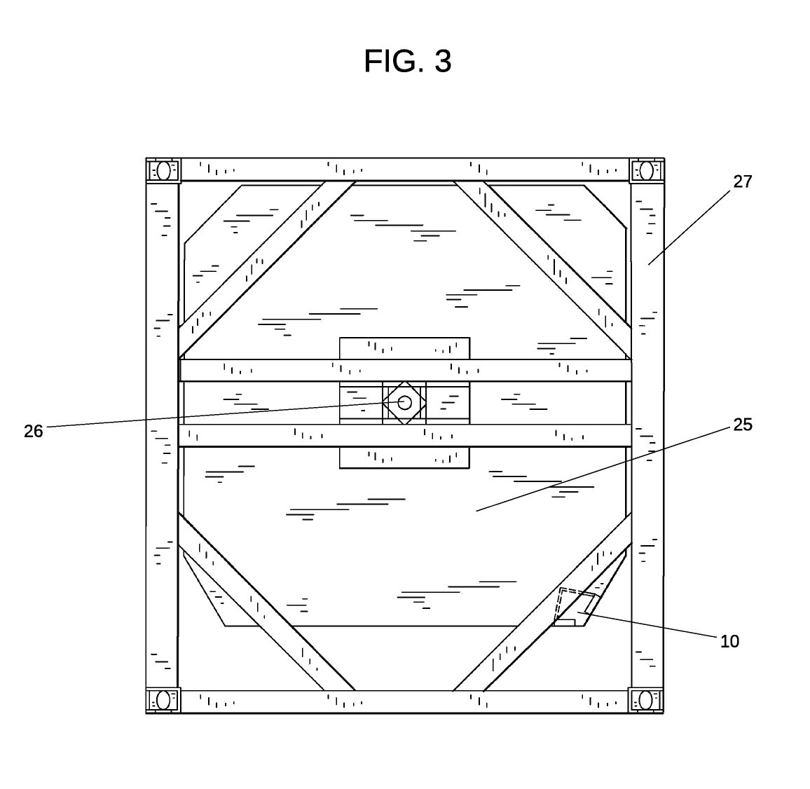

As illustrated in FIG. 3, a preferred embodiment of a version of the invention is based on the use of the container offload system 10 positioned in the lower section of a tank 25. In one embodiment, the tank 25 is capable of rotation by a rotator 26. Preferably, the tank 25 and rotator 26 are connected to an exoskeleton 27. In one embodiment, a version of the invention is for shipping containers. In another embodiment, a version of the invention is for a container for onsite storage. In yet another embodiment, the invention is for an intermodal container.

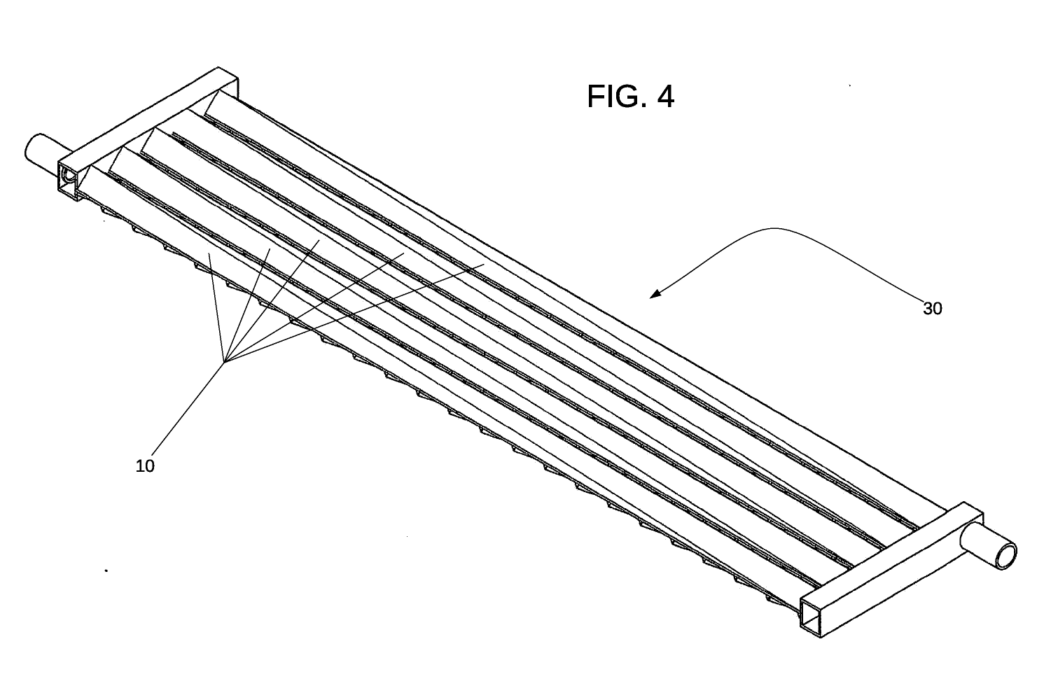

As shown in FIG. 4, a version of the invention comprises a combination of at least two container offload systems 10 connected to form a combination container offload system 30. The combination container offload system 30 is placed in the bottom of a container for unloading materials and commodities. A version of the combination offload system 30 can be retrofitted into standard shipping and storage containers. Furthermore, versions of the offload system 30 may be retrofitted to fit in the hull of a marine vessel.

In one embodiment of a version of the invention, a container offload system comprising a combination of at least two container offload systems is disclosed. As illustrated in FIG. 4, a version of the invention comprises at least two container offload systems being connected to form a group of container offload systems. In one embodiment, the group of container offload systems are placed in the bottom of a container for unloading goods.

A preferred method of unloading a shipping container comprises filling a shipping container equipped with a container offload system described and claimed herein with a commodity. The filled shipping container is transported to an offload destination. At the offload destination, in one embodiment, a hose is attached to the offload system. Preferably, the hose is attached to a valve, which is in turn connected to the offload system. Once the hose is attached, a pressure change is created in the offload system. This pressure change may occur as a result of a wind velocity or vacuum. In one embodiment applying vacuum creates a pressure change. In another embodiment, a wind velocity, such as with a fan, creates a pressure change. The pressure change causes the commodity to move from the container to the offload system, from the offload system to the hose, and from the hose to the unloading area.

The offload system may be constructed from a wide variety of materials. Thus, it is understood that the invention covers the use of all materials. Preferably, the offload system will be comprised of strong metal such as steel. However, versions of the invention may be made of other metals. Additionally, versions of the invention are made of strong plastics and resins. It is understood that versions of the invention may be comprised of other materials, both natural and synthetic.

Furthermore, it is understood that the spacers may be made from any material. Preferably, the spacers are made of hardened rubber, metal, or plastic. Nevertheless, different versions of the invention are made of different materials. It is understood that versions of the invention cover the use of these different materials in the manner set forth herein, and in the claims.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter can be made without departing from the principles and scope of the inventive subject matter as expressed in the subjoined claims.

What is claimed is:

1. An offload system, comprising:
a. an upper section and a lower section,
b. the upper section being attached to the lower section,
c. a plurality of spacers connected to the lower section, and
d. the lower section having space for material to pass.

2. A container offload system as in (1), further comprising:
a. the upper section comprises a left and right piece,
i. each left and right piece of the upper section comprises a high and low side,
ii. the high side of each left and right piece of the upper section are joined together at a central point,
b. the lower section comprises a left piece and a right piece,
i. each left and right piece of the lower section comprises a high and low side,
ii. the high side of the left piece of the bottom section is in contact with the low side of the left piece of the upper section,
iii. the high side of the right piece of the bottom section is in contact with the lower side of the right piece of the upper section,
iv. the low side of the right piece of the bottom section and the low side of the left piece bottom section create a space there between.

3. A container offload system as in (2), further comprising:
a. the left and right pieces making up the lower section have a top and bottom side,
b. the lower section has spacers connected to the bottom side of the lower section in contact with goods stored in the container.

4. A container offload system as in (3), further comprising, the spacers attached to the lower section have a triangular configuration.

5. A container offload system as in (3), further comprising,
a. the spacers are attached to the left and right pieces of the lower section,
b. the spacers of the left side of the lower section are staggered with the spacers of the right side of the lower section.

6. A container offload system as in (5), further comprising the staggering being such that a gap between two spacers on the left piece of the lower section sits opposite from a spacer on the right piece of the lower section.

7. A container offload system as in (1), further comprising:
a. the lower section is made up of a left and right piece,
b. the spacers are attached to the left and right pieces of the lower section,
c. the spacers of the left side of the lower section are staggered with the spacers of the right side of the lower section,
d. the staggering being such that a gap between two spacers on the left piece of the lower section sits opposite from a spacer on the right piece of the lower section.

8. A container offload system comprising:
a. a longitudinal body with an open bottom for commodities to pass,
b. the longitudinal body forming a channel therein,
c. the commodities passing through the open bottom into the channel,
d. the longitudinal body having an upper and lower section,
e. the upper section forming the upper portion of the longitudinal body,
f. the upper section of the longitudinal body being joined together,
g. the lower section of the longitudinal body not being joined together and having a separation for commodities to pass.

9. A container offload system as in (8), further comprising:
a. the lower section of the longitudinal body having spacers attached thereto,
b. the spacers being attached to both sides of the lower section of the longitudinal body,
c. the spacers being attached to the longitudinal body lower section so as to be in contact with the commodity.

10. A container offload system as in (9), further comprising, the spacers are triangles.

11. A container offload system as in (9), further comprising,
a. the spacers are triangles having a flat bottom and a pointed top,
b. the flat bottom is located near the open space at the bottom of the longitudinal section lower body, and
c. the top point is located farthest away from the open space at the bottom of the longitudinal section lower body.

12. A container offload system as in claim 11), further comprising, the spacers are staggered on each side of the longitudinal body lower section such that the middle of the bottom section of a spacer on one side of the longitudinal section lower body is opposite the space between two spacers on the opposite side of the longitudinal section lower body.

13. A container offload system as in claim 12), the container being a shipping container.

14. A container offload system as in claim 12), the container being a container for onsite storage.

15. A container offload system as in claim 12), the container being an intermodal container.

16. A container offload system comprising:
a. a combination of at least two container offload systems of claim 12),
b. the container offload systems being connected to form a group of container offload systems, and
c. the group of container offload systems being placed in the bottom of a container for unloading goods.

17. The container offload system of claim 1, further comprising:
a. the offload system having a front end and a back end, and
b. each end of the offload system being connected to a valve.

18. The container offload system of claim 8, further comprising,
a. the offload system having a front end and a back end,
b. each end of each individual longitudinal body is connected to a common commodity aggregator,
c. the common commodity aggregator is comprised of an isolated compartment area for receiving commodities from each individual offload system, and
d. the common commodity aggregator having a valve connected thereto.

19. The method of unloading a shipping container comprising,
a. filling a shipping container equipped with the container offload system of claim 8 with a commodity,
b. transporting the filled container to an offload destination,
c. attaching a hose to the offload system,
d. creating a pressure change in the offload system,
e. the pressure change causing the commodity to move from the container to the offload system, from the offload system to the hose, and from the hose to the unloading area.

20. The method of claim 19, further comprising, the pressure change causing the commodity to move from the container to the offload system, from the offload system to the hose, and from the hose to the unloading area is created by applying a vacuum.

21. The method of claim 19, further comprising, the pressure change causing the commodity to move from the container to the offload system, from the offload system to the hose, and from the hose to the unloading area is by applying wind velocity.
